(19) United States
(12) Patent Application Publication
(10) Pub. No.: US 2013/0078603 A1
(43) Pub. Date: Mar. 28, 2013

(54) ARM MODEL APPARATUS FOR INTRAVENOUS INJECTION TRAINING

(71) Applicants: Seung Jin YANG, Wonju-si (KR); In Bae CHANG, Seoul (KR); Nam Hyuk KIM, Wonju-si (KR)

(72) Inventors: Seung Jin YANG, Wonju-si (KR); In Bae CHANG, Seoul (KR); Nam Hyuk KIM, Wonju-si (KR)

(21) Appl. No.: 13/605,419

(22) Filed: Sep. 6, 2012

(30) Foreign Application Priority Data
Sep. 26, 2011 (KR) 10-2011-0096822
Jul. 10, 2012 (KR) 10-2012-0074855

(51) Int. Cl. G09B 23/28

(52) U.S. Cl. 434/268

(57) ABSTRACT

The present invention provides an arm model apparatus for intravenous injection training, comprising: an arm model having an insertion grooved recess formed on a top thereof, the arm model being formed such that the arm model are twisted so as to allow the back of a hand part and a cubital fossa to be oriented upwardly; a skin pad detachably mounted into the insertion grooved recess and having a blood vessel-imitating tube formed therein; a pump drive unit connected to the a blood vessel-imitating tube by a pad connecting tube; and a liquid blood supply container connected to the pump drive unit by a container connecting tube and configured to supply blood stored therein to the blood vessel-imitating tube. The inventive arm model apparatus implements a realistic skin sensation as if a syringe needle penetrated through the blood vessel of the human body through the arm model.

### CROSS-REFERENCE TO RELATED APPLICATIONS

This application claims the benefits of Korean Patent Application Nos. 10-2011-0096822 and 10-2012-0074855, filed with the Korean Intellectual Property Office on Sep. 26, 2011 and Jul. 10, 2012, respectively, the disclosure of which is incorporated herein by reference in its entirety.

### BACKGROUND OF THE INVENTION

1. Field of the Invention

Exemplary embodiments of the present invention relate to an arm model apparatus for intravenous injection training, and more particularly to such an arm model apparatus for intravenous injection training, which includes an arm model, a skin pad configured to be attachable to the arm model, and a pump driver unit and a liquid blood supply container which are configured to supply blood, thereby exhibiting the same effect as that obtained when an intravenous injection is carried out into the human body.

2. Background of the Related Art

An intravenous injection intended for both the infusion of an injectable solution and the supply of blood and electrolyte is widely used in an emergency situation and a general injectable situation. Such an intravenous injection is a medical practice that all the medical staffs must master necessarily.

A repeated injection practice is required in order to attain proficiency in the intravenous injection. However, in the case where a learner carries out the intravenous injection into an actual human body, there occurs a problem in that a subject suffers from a pain and a secondary damage when a syringe needle does not smoothly penetrate through the skin of a subject. For this reason, a practice mannequin for learning intravenous injection is developed and supplied.

However, such a practice mannequin for learning intravenous injection entails a problem in that since it consists of a blood vessel-imitating tube and a human skin-imitating skin pad made of a silicon or rubber material separately, an infusion solution is leaked and durability is deteriorated.

FIG. 9 is a reference view illustrating an installation state of a conventional practice terminal device for learning virtual intravenous injection.

In an attempt to solve the above-mentioned problem, there is disclosed Korean Patent Laid-Open Publication No. 10-2010-0122172 entitled “Practice Terminal Device for Learning Virtual Intravenous Injection” as shown in FIG. 9. This practice terminal device is a sort of peripheral device for a virtual blood vessel learning machine, which is connected to a known virtual blood vessel injection learning machine allowing a learner to masters how the learner searches a vein from a body of a virtual model displayed on a screen by executing application program stored in a database, and how the learner carries out the intravenous injection into the body of the virtual model, so that it is operated in cooperation with application program executed in the virtual blood vessel injection learning machine through a control unit to allow the learner to master how to carry out the intravenous injection into a subject realistically. That is, the above patent document proposes a technology in which visual perception and tactile perception are made simultaneously in the course of searching a vein, particularly the learner senses pulsation by the repeated inflow and outflow of operation fluid, and thus can perform a vein searching practice more realistically. In addition the above conventional practice terminal device proposes that the learner can make a practice of carrying out the intravenous injection as if an intravenous injection needle sequentially penetrated through the epidermis, the muscular layer, and the vascular layer of the human body skin. However, the above laid-open patent still has a shortcoming in that the learner depends on only the tactile sense of the learner's fingers and an image displayed on a monitor screen to make a practice of carrying out the intravenous injection, thus lowering a sense of reality, and efficiency is reduced when the above practice terminal device is applied to the human body even though the learner makes a repeated practice using the practice terminal device because the state of the skin and the thickness of the blood vessel vary depending on each human body

### SUMMARY OF THE INVENTION

Accordingly, the present invention has been made to solve the above-mentioned problems involved in the conventional prior art, and it is an object of the present invention to provide an arm model apparatus for intravenous injection training, which is provided with a skin pad that is easily detachably mounted on a body of an arm model that imitates an actual human arm, and a pump drive unit that supplies liquid blood at the same flow rate as that of actual blood, so that a learner can feel an injection reaction force while giving an injection to the arm model and many learners can continuously use the arm model apparatus, thereby improving water leakage preventive effect and durability, and thus practicing carrying out realistic intravenous injection and taking blood.

Another object of the present invention is to provide an arm model apparatus for intravenous injection training, which is provided with remote control transmitter and receiver parts so that a plurality of arm model apparatuses for intravenous injection training can be controlled remotely, and thus practice and evaluation of a number of medical staffs can be performed simultaneously.

To achieve the above object, the present invention provides an arm model apparatus for intravenous injection training, including: an arm model having an insertion grooved recess formed on a top thereof, the arm model being formed such that the arm model is twisted so as to allow the back of a hand part and a cubital fossa to be oriented upwardly; a skin pad detachably mounted into the insertion grooved recess and having a blood vessel-imitating tube formed therein; a pump drive unit connected to the a blood vessel-imitating tube by a pad connecting tube; and a liquid blood supply container connected to the pump drive unit by a container connecting tube and configured to supply blood stored therein to the blood vessel-imitating tube.

Preferably, a skin texture of the skin pad may be formed as a triple-layered structure consisting of an epidermal layer, a dermal layer, and a subcutaneous fat layer, or a double-layered structure consisting of an outer layer and a subcutaneous fat layer, and the blood vessel-imitating tube may be formed annularly in the subcutaneous fat layer and may have a blood vessel-branching part formed at one side thereof.

Preferably, the pump drive unit may include a pump, a pump driving controller configured to control the drive of the pump to make the circulating rate of the blood similar to that of blood flowing through a blood vessel of the human body, a timer switch including a alarm generator configured to produce a signal sound to cause the supply of blood to be stopped when an inputted predetermined time is lapsed so as to facilitate practice and evaluation of the carrying out of the intravenous injection, and a pump accelerating switch configured to allow blood to be supplied to the blood vessel-imitating tube if it is empty and facilitate washing of the blood vessel-imitating tube.

Preferably, the pump drive unit may include a remote controller that drives and stops a plurality of arm model apparatuses remotely to synchronize the start and the end during the practice, training, and evaluation.

Preferably, the arm model and the skin pad may be constructed such that the skin pad can be attached to and detached from the arm model by a detachable pad attached to the underside of the skin pad, the detachable pad being attached with any one of adhesive tape, Velcro, magnet, and adhesive.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view illustrating an arm model apparatus for intravenous injection training according to a preferred embodiment of the present invention;

FIG. 2 is a conceptual view illustrating the blood flow process according to a preferred embodiment of the present invention;

FIG. 3 is a schematic view illustrating remote control transmitter and receiver parts according to a preferred embodiment of the present invention;

FIG. 4 is a schematic view illustrating a blood vessel-imitating tube of an arm model apparatus for intravenous injection training according to a preferred embodiment of the present invention;

FIGS. 5(a) and 5(b) are cross-sectional views illustrating a skin pad of an arm model apparatus for intravenous injection training according to a preferred embodiment of the present invention;

FIG. 6 is a cross-sectional view illustrating an arm model of an arm model apparatus for intravenous injection training according to a preferred embodiment of the present invention;

FIG. 7 is a perspective view illustrating an arm model apparatus for intravenous injection training according to another preferred embodiment of the present invention;

FIG. 8 is a view illustrating a side end of an arm model of an arm model apparatus for intravenous injection training according to another preferred embodiment of the present invention; and

FIG. 9 is a reference view illustrating an installation state of a conventional practice terminal device for learning virtual intravenous injection.

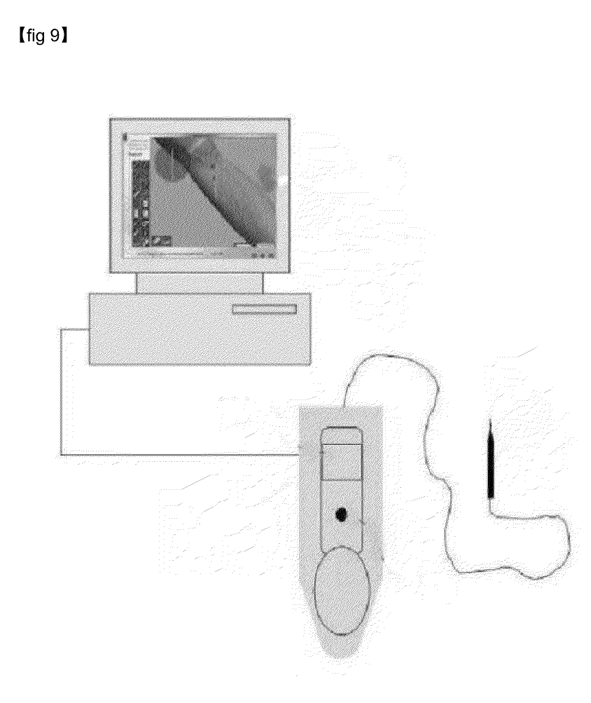

### EXPLANATION ON SYMBOLS

100: arm model apparatus for intravenous injection training
10: arm model
12: insertion grooved recess 20: skin pad
22: blood vessel-imitating tube 24: blood vessel-branching part
29: detachable pad 30: liquid blood supply container
40: pump drive unit 45: pump
46: pump driving controller
47: pump accelerating switch

### DETAILED DESCRIPTION OF THE PREFERRED EMBODIMENTS

Now, an arm model apparatus for intravenous injection training according to the preferred embodiments of the present invention will be described hereinafter in more detail with reference to the accompanying drawings.

Here, the terminology or words used in the specification and the claims of the present invention should not interpreted as typical meanings or lexical meanings, and they should be interpreted as the meaning and concept conforming to the technological idea of the present invention on the basis of the idea that the inventor can define the concept of the words appropriately in order to illustrate his invention in the best manner.

Therefore, embodiments described herein and configurations illustrated in the drawings are merely the most preferred embodiments of the present invention, and do not represent all of the technical spirits of the present invention. So, it should be understood that various equivalents or modifications substituting for the embodiments could exist at a time point of the application of the present invention.

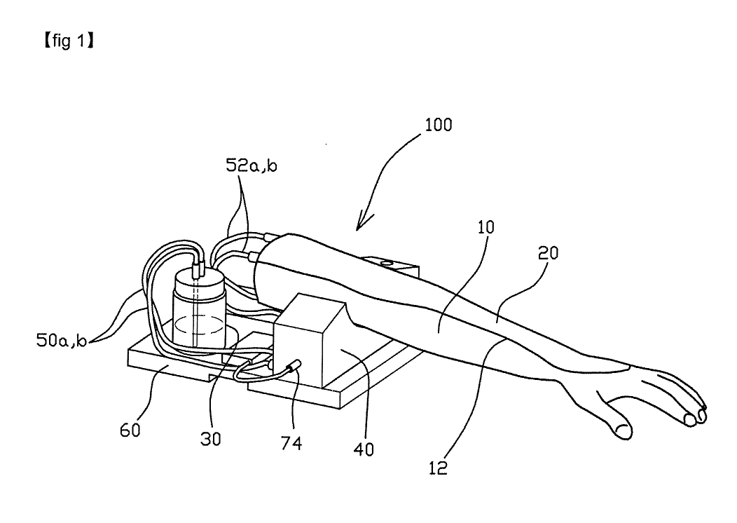

FIG. 1 is a perspective view illustrating an arm model apparatus for intravenous injection training according to a preferred embodiment of the present invention.

As shown in FIG. 1, the arm model apparatus 100 for intravenous injection training according to a preferred embodiment of the present invention includes an arm model 10, a skin pad 20 fixedly coupled to a top of the arm model and has a blood vessel-imitating tube 22 formed therein, a liquid blood supply container 30 that stores blood therein and supplies the blood to the blood vessel-imitating tube 22, a pump drive unit 40 that allows the blood stored in the liquid blood supply container 30 to be supplied to the blood vessel-imitating tube 22, container connecting tubes 50a and 50b that interconnect the pump drive unit 40 and the liquid blood supply container 30, pad connecting tubes 52a and 52b that interconnect the pump drive unit 40 and the blood vessel-imitating tube, and a base plate 60.

The arm model 10 is made of a brachial part that is the arm region between the shoulder and the elbow, an antebrachial part that is the forearm region between the elbow and the wrist, and a hand part. The arm model 10 is formed such that the brachial part and the antebrachial part are twisted so as to allow the back of the hand part and a cubital fossa, i.e., the depression located on anterior elbow to be oriented upwardly.

The arm model 10 is preferably molded of a soft silicon, urethane, or rubber material so as to have a pattern and a sensation similar to those of the arm of the human body. The arm model 10 has a dovetail-shaped insertion grooved recess 12 formed a top thereof so as to extend from the brachial part to a predetermined part of the back of the hand part via the antebrachial part so that the skin pad 20 can be fixedly attached to the arm model 10 through the insertion grooved recess 12.

The skin pad 20 is configured to be seated on a top of the arm model 10, and has the blood vessel-imitating tube 22 penetrated annularly therein.

The container connecting tubes 50a and 50b are connected at one ends thereof to a top of the liquid blood supply container 30, and are connected at the other ends thereof to blood inflow and outflow connectors 43 and 44 of the pump drive unit 40, which will be described later. In addition, the liquid blood supply container 30 is preferably made of a glass or synthetic resin material so as to directly view the blood contained therein. Further, the liquid blood supply container 30 is formed in a cylindrical or hexahedral shape and is preferably arranged in scales from the bottom to the top although not shown so as to visibly check the amount of blood contained in the liquid blood supply container 30.

The pump drive unit 40 serves to suck in the blood contained in the liquid blood supply container 30 through the container connecting tube 50a to cause the sucked blood to flow through the blood vessel-imitating tube 22 inserted into the skin pad 20, and the blood having flowed through the blood vessel-imitating tube 22 to be again introduced into the liquid blood supply container 30 through the container connecting tube 50b.

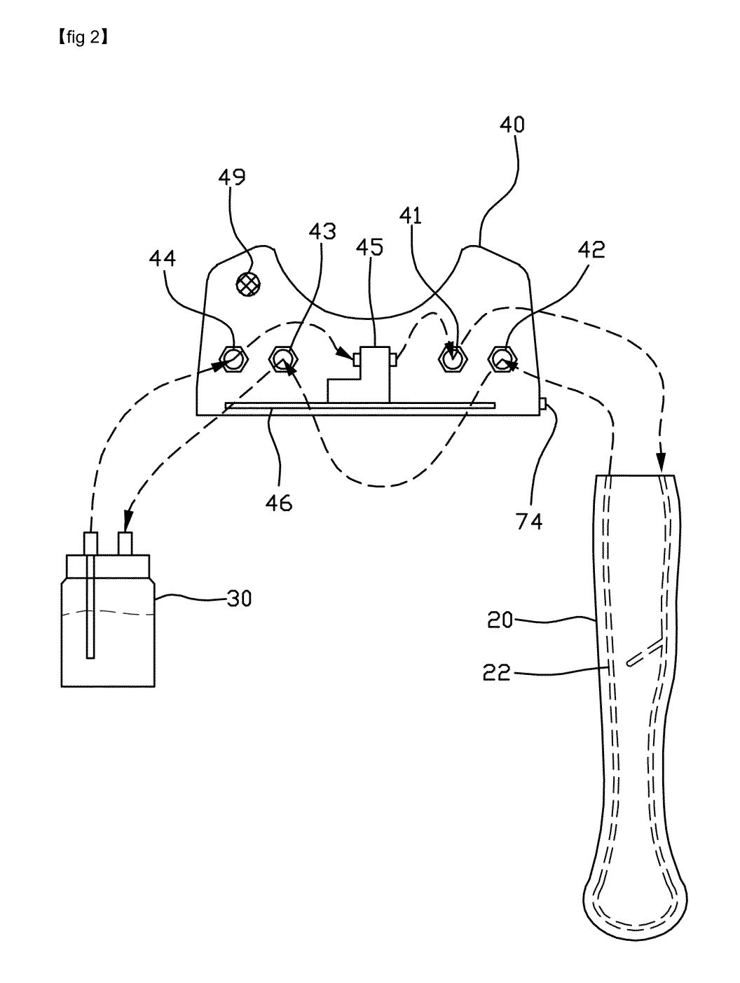

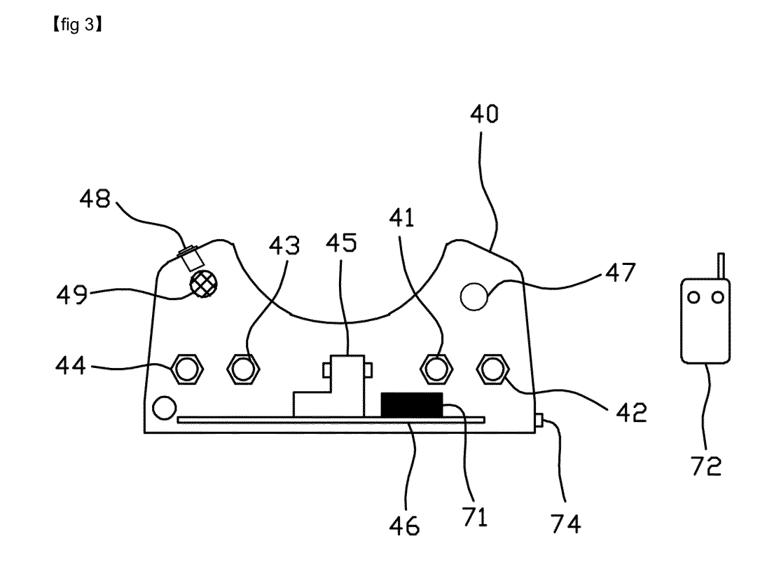

FIG. 2 is a conceptual view illustrating the blood flow process according to a preferred embodiment of the present invention, and FIG. 3 is a schematic view illustrating remote control transmitter and receiver parts according to a preferred embodiment of the present invention.

The pump drive unit 40 will be described hereinafter with reference to FIGS. 2 and 3.

The pump drive unit 40 includes a pump 45 that acts to suck in blood from the liquid blood supply container 30 and supply the sucked blood to the blood vessel-imitating tube 22, and a pump driving controller 46 that acts to control the drive of the pump to make the circulating rate of the blood similar to that of blood flowing through a blood vessel of the human body.

In addition, the pump drive unit 40 includes a pump accelerating switch 47 and a timer switch 48. The pump accelerating switch 47 serves to allow blood to be rapidly filled in the blood vessel-imitating tube 22 when the carrying out of intravenous injection is practiced initially or there is no blood in the blood vessel-imitating tube 22, and facilitates washing of the blood vessel-imitating tube.

The timer switch 48 includes an LED lamp and a sound generator 49 that produces a signal sound. When the timer switch is pressed, the pump is operated to cause blood to be circulated and the LED is turned on. When a predetermined time is lapsed, the alarm generator 49 produces a signal sound to alarm that the practice time is terminated.

The pump drive unit 40 includes blood inflow and outflow connectors 41 and 42 for the skin pad, and blood inflow and outflow connectors 43 and 44 for the liquid blood supply container, which are formed at a front surface thereof. The blood inflow and outflow connectors 41 and 42 for the skin pad, and the blood inflow and outflow connectors 43 and 44 for the liquid blood supply container are connected to the pad connecting tubes 52a and 52b and the container connecting tubes 50a and 50b, respectively. The flow of blood is performed in a circulating structure in which blood flows out of liquid blood supply container 30, passes through the blood vessel-imitating tube 22 formed in the skin pad 20, and flows into the liquid blood supply container 30.

The pump drive unit 40 includes a remote control receiver part 71 mounted therein and a remote control transmitter part 72 disposed at the outside thereof, so that the remote control receiver part can be remotely controlled and a plurality of arm model apparatuses for intravenous injection training can be driven and stopped by the remote control transmitter part 72, thereby enabling practice and evaluation of a number of medical staffs to be performed simultaneously.

The pump drive unit 40 is preferably formed in a semicircular shape at a top thereof so as to serve as a base plate of the arm model, on which the arm model can be seated.

The pump drive unit 40 has a power connector 74 formed thereon so as to be connected to an external power supply, so that it can be driven by a general commercial power supply. In addition, a battery is mounted at the inside or outside of the pump drive unit 40 due to a low consumption power, so that it can be used as a drive power supply anywhere irrespective of a practice place.

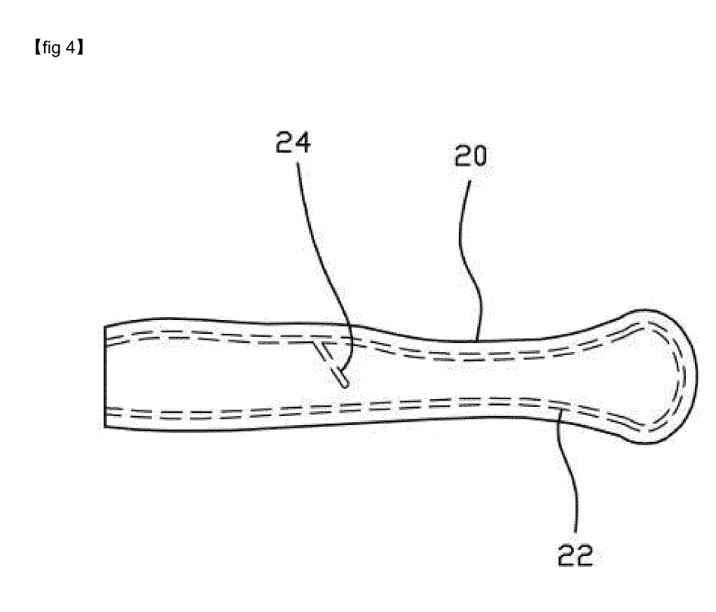

FIG. 4 is a schematic view illustrating a blood vessel-imitating tube of an arm model apparatus for intravenous injection training according to a preferred embodiment of the present invention.

As shown in FIG. 4, the blood vessel-imitating tube 22 is inserted into the skin pad 20 in an annularly shape, and has a blood vessel-branching part 24 formed at or bonded to a cubital fossa of the arm model.

The blood vessel-branching part 24 is penetratingly formed at one side of a portion in which blood is introduced and is closed at the other side the blood introduced portion, so that it serves as a capillary in a blood vessel of the human body and corresponds to a blood collection position during the practice of carrying out the intravenous injection. Thus, the blood vessel-branching part has a blood vessel arrangement structure that maximizes reality of blood collection, injection and practice.

Such a blood vessel arrangement structure can be implemented in various patterns through a change in molding, adhesion, and thickness of the blood vessel-imitating tube 22 and the blood vessel-branching part 24.

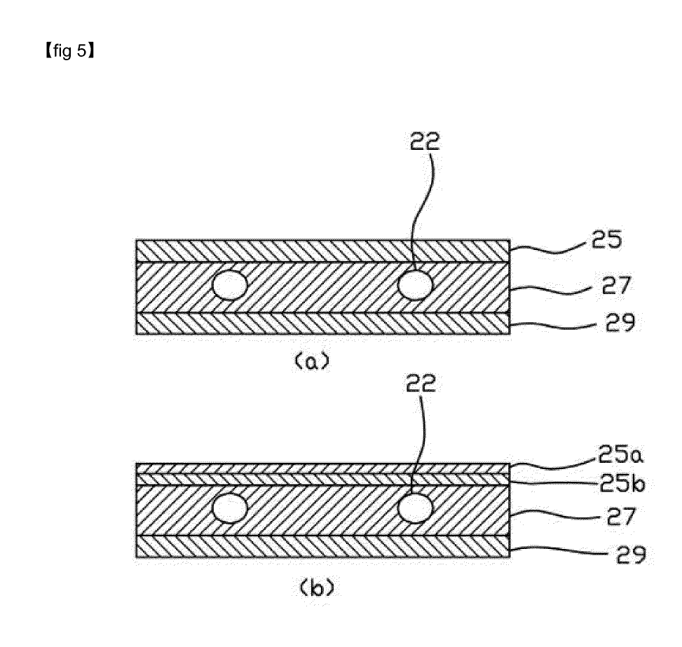

FIGS. 5(A) and 5(B) are cross-sectional views illustrating a skin pad of an arm model apparatus for intravenous injection training according to a preferred embodiment of the present invention.

As shown in FIG. 5(a), the skin pad 20 can be composed of an outer layer 25, a subcutaneous fat layer 27, a blood vessel-imitating tube 22, and a detachable pad 29. As shown in FIG. 5(b), the outer layer 25 may be composed of an epidermal layer 25a and a dermal layer 25b.

An outer layer of a general human body has a thickness of from 0.5 mm to 2 mm and a shore hardness of from 0 A to 20 A. Thus, the outer layer 25 is formed to a thickness of from 0.5 mm to 2 mm using a silicon or soft urethane material having a shore hardness of 10 A. A metal plate etching or coating method is preferably used to implement a realistic skin feeling.

The subcutaneous fat layer 27 is preferably formed to a thickness of from 3 mm to 5 mm using a silicon or soft urethane material having a shore hardness of from 0 A to 10 A in order to have a sensation similar to that of the human body to the maximum.

The diameter of a general blood vessel of the human body ranges from 4 mm to 5 mm, and the thickness of the vein blood vessel is approximately 0.5 mm or so. Thus, blood vessel-imitating tube 22 is preferably formed as a silicon tube having an outer diameter of from 4 mm to 5 mm and an inner diameter of from 3 mm to 4 mm.

A double-layered structure consisting of the outer layer 25 and the subcutaneous fat layer 27 or a triple-layered structure consisting of the epidermal layer 25a, the dermal layer 25b, and the subcutaneous fat layer 27 minimize leakage of blood in the course of practicing carrying out the intravenous injection and increase the practice lifespan of the skin pad 20, thereby enabling an economic and realistic practice.

Moreover, the material of the epidermal layer, the dermal layer, and the subcutaneous fat layer is translucent, and thus the blood vessel-imitating tube 22 inserted into the skin pad can be visibly checked externally.

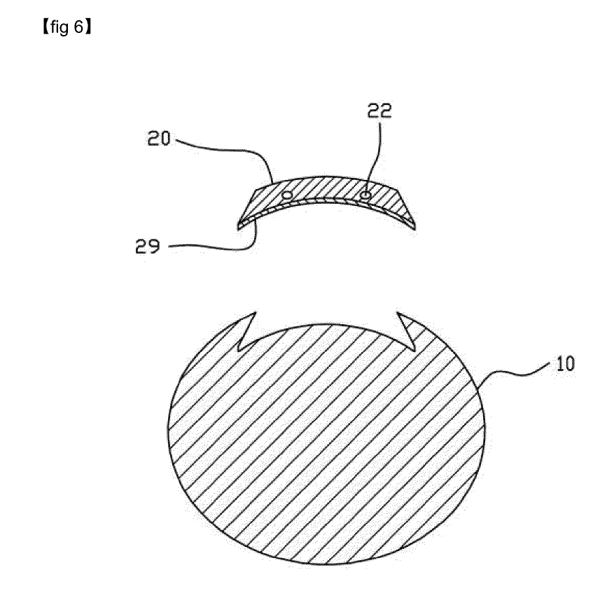

FIG. 6 is a cross-sectional view illustrating an arm model of an arm model apparatus for intravenous injection training according to a preferred embodiment of the present invention.

The detachable pad 29 is attached to the underside of the skin pad 20 to facilitate the attachment and detachment of the skin pad 20 to and from the arm model 10.

The detachable pad 29 is attached or coated with adhesive tape, Velcro, magnet, or adhesive so that it is adhered to the dovetail-shaped insertion grooved recess 12 formed on the top surface of the arm model 10 to facilitate attachment and detachment of the skin pad to and from the arm model.

The skin pad 20 and the arm model 10 can be easily attached and detached to and from each other by the above-mentioned material, and can facilitate the intravenous injection practice as well as can be stored separately after use thereof.

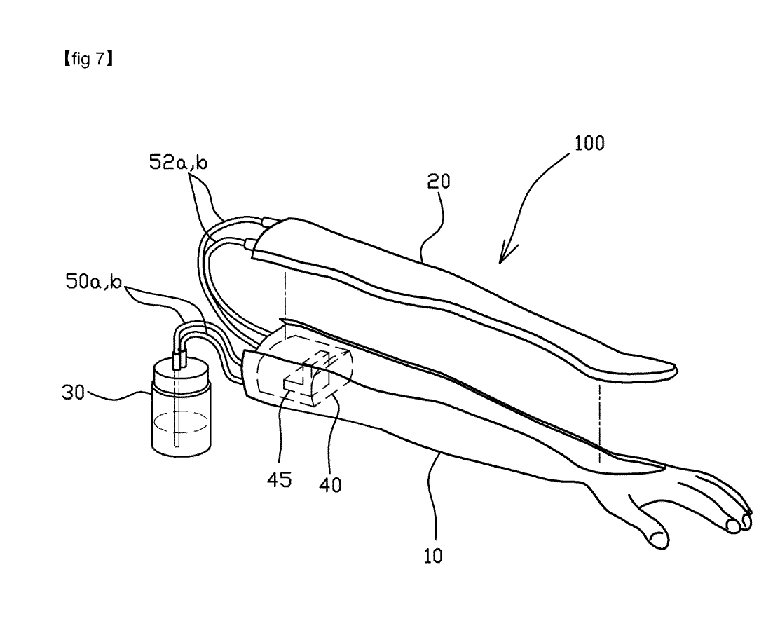

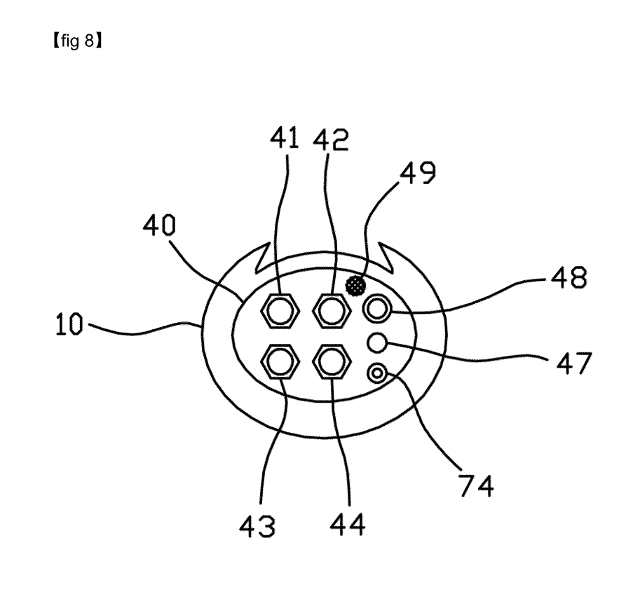

FIG. 7 is a perspective view illustrating an arm model apparatus for intravenous injection training according to another preferred embodiment of the present invention, and FIG. 8 is a view illustrating a side end of an arm model of an arm model apparatus for intravenous injection training according to another preferred embodiment of the present invention; and

As shown in FIG. 7, in the arm model apparatus 100 for intravenous injection training according to another embodiment of the present invention, the pump drive unit 40 is simplified such that the pump drive unit 40 is downsized so as to be provided in a separate space formed in the arm model 10 and is easy to carry.

As shown in FIG. 8, at a side end of the arm model 10 are formed a pump drive unit 40 including blood inflow and outflow connectors 41 and 42 for the skin pad, blood inflow and outflow connectors 43 and 44 for the liquid blood supply container, a power connector 74, a pump accelerating unit 47, a timer switch 48, and an alarm generator 49. Other elements are located within the arm model 10.

The operation of the arm model apparatus for intravenous injection training according to the present invention as constructed above will be described hereinafter.

First, in the case where it is desired to practice carrying out the intravenous injection using the arm model apparatus according to the present invention, when there is no blood in the blood vessel-imitating tube, the pump accelerating switch 47 is pressed to cause blood to be supplied from the liquid blood supply container 30 to the blood vessel-imitating tube 22 formed in the skin pad 20 to rapidly fill the blood vessel-imitating tube with blood, and then the timer switch 48 is pressed.

Then, when the timer switch 48 is pressed, blood contained in the blood vessel-imitating tube 22 starts to circulate and simultaneously the LED lamp is turned on, so that a learner can make a desired practice such as collecting blood or giving an injection. When the circulating rate of the blood during the practice needs to be controlled, it can be controlled using the pump driving controller 46. When a predetermined practice time is lapsed, the alarm generator 49 of the time switch produces a signal sound to alarm that the practice time is terminated. When it is desired to restart to make a practice, the timer switch or the remote control transmitter part 72 is manipulated.

The arm model apparatus 100 for intravenous injection training of the present invention enables the timer switch 48 to drive the pump and produce a signal sound indicating the termination of the practice based on a predetermined limit time to allow a learner to easily check whether or not the intravenous injection practice is completed within the predetermined time so that practice and evaluation of the carrying out of the intravenous injection is facilitated.

In addition, after the practice is completed using the arm model apparatus for intravenous injection training according to the present invention, the container connecting tube 50a is separated from the liquid blood supply container 30 and then the pump accelerating switch 47 is pressed to collect the remaining blood in the liquid blood supply container 30. When the remaining blood is totally collected in the liquid blood supply container 30, it is stored in an empty container and the liquid blood supply container 30 is filled with clean water. Thereafter, the container connecting tube 50a is again connected to the liquid blood supply container 30 and the pump accelerating switch 47 is pressed. Then, clean water is circulated to cleanly wash passages through which blood of each tube flows. In this manner, the pump accelerating switch 47 allows blood to be rapidly supplied and facilitates washing the blood passages.

As described above, the arm model apparatus for intravenous injection training according to the present invention implements a realistic skin sensation as if a syringe needle penetrated through the skin and the blood vessel of the human body through the arm model so that a learner can perform the intravenous injection training while feeling the realistic skin sensation similar to that of an actual human body.

In addition, medical training such as drug infusion through the intravenous injection, catheterization, blood sample collection, and the like is possible, the replacement and installation of the skin pad is facilitated to make the practice easy, blood leakage does not occur, durability is excellent, and practice and evaluation of a number of medical staffs can be performed simultaneously by the remote controller.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

What is claimed is:

1. An arm model apparatus for intravenous injection training, comprising:
an arm model having an insertion grooved recess formed on a top thereof, the arm model being formed such that the arm model is twisted so as to allow the back of a hand part and a cubital fossa to be oriented upwardly;
a skin pad detachably mounted into the insertion grooved recess and having a blood vessel-imitating tube formed therein;
a pump drive unit connected to the a blood vessel-imitating tube by a pad connecting tube; and
a liquid blood supply container connected to the pump drive unit by a container connecting tube and configured to supply blood stored therein to the blood vessel-imitating tube.

2. The arm model apparatus according to claim 1, wherein a skin texture of the skin pad is formed as a triple-layered structure consisting of an epidermal layer, a dermal layer, and a subcutaneous fat layer, or a double-layered structure consisting of an outer layer and a subcutaneous fat layer, and wherein the blood vessel-imitating tube is formed annularly in the subcutaneous fat layer and has a blood vessel-branching part formed at one side thereof.

3. The arm model apparatus according to claim 1, wherein the pump drive unit comprises a pump, a pump driving controller configured to control the drive of the pump to make the circulating rate of the blood similar to that of blood flowing through a blood vessel of the human body, a timer switch including an alarm generator configured to produce a signal sound to cause the supply of blood to be stopped when an inputted predetermined time is lapsed so as to facilitate practice and evaluation of the carrying out of the intravenous injection, and a pump accelerating switch configured to allow blood to be supplied to the blood vessel-imitating tube if it is empty and facilitate washing of the blood vessel-imitating tube.

4. The arm model apparatus according to claim 1, wherein the pump drive unit comprises a remote controller that drives and stops a plurality of arm model apparatuses remotely to synchronize the start and the end during the practice, training, and evaluation

5. The arm model apparatus according to claim 1, wherein the arm model and the skin pad are constructed such that the skin pad can be attached to and detached from the arm model by a detachable pad attached to the underside of the skin pad, the detachable pad being attached with any one of adhesive tape, Velcro, magnet, and adhesive.
